(19) United States
(12) Patent Application Publication
(10) Pub. No.: US 2026/0259824 A1
(43) Pub. Date: Sep. 3, 2026

(54) MEMORY ACCESS PREDICTION

(71) Applicant: Arm Limited, Cambridge (GB)

(72) Inventors: Houdhaifa BOUZGUARROU, Valbonne (FR); Ho-Seop KIM, Austin, TX (US); Michael Brian SCHINZLER, Round Rock, TX (US); Rishabh Srikrishnan CHITOOR, Austin, TX (US)

(21) Appl. No.: 19/068,251

(22) Filed: Mar. 3, 2025

(51) Int. Cl. G06F 12/02

(52) U.S. Cl. CPC G06F 12/0223

(57) ABSTRACT

There is provided an apparatus comprising a storage hierarchy. The storage hierarchy comprises: storage circuitry configured to store a plurality of data items, and a downstream storage component. The apparatus is also provided with control circuitry responsive to receipt of a memory access request specifying an address from which content is to be retrieved, to perform a prediction of whether the content is present in the storage circuitry, and when the prediction indicates that the content is absent from the storage circuitry, to issue a storage bypass request to trigger a downstream lookup of the content in the downstream storage component. The control circuitry is configured to receive a hint from upstream of the storage circuitry, the hint indicative of whether the address belongs to a set of addresses previously observed by the processing circuitry, and to perform the prediction in dependence on the hint.

### TECHNICAL FIELD

The present invention relates to data processing. More particularly the present invention relates to an apparatus, a system, a chip-containing product, a method, and a computer-readable medium.

### BACKGROUND

Some apparatuses are provided with a storage hierarchy for storing content to be retrieved in response to access requests. Storage structures in the storage hierarchy that are located further from processing circuitry may take a greater number of clock cycles to access than storage structures that are located closer to the processing circuitry in the storage hierarchy.

### SUMMARY

According to a first aspect of the present techniques there is provided an apparatus comprising:
a storage hierarchy for storing data items to be processed by processing circuitry, the storage hierarchy comprising:
storage circuitry configured to store a plurality of the data items; and
at least one downstream storage component accessible to the processing circuitry in a greater number of clock cycles than the storage circuitry; and
control circuitry responsive to receipt of a memory access request specifying an address from which content is to be retrieved, to perform a prediction of whether the content is present in the storage circuitry prior to receiving a result of a lookup to confirm whether the content is present, and when the prediction indicates that the content is absent from the storage circuitry, to issue a storage bypass request to trigger a downstream lookup of the content in the at least one downstream storage component,
wherein the control circuitry is configured to receive a hint from upstream of the storage circuitry, the hint indicative of whether the address belongs to a set of addresses previously observed by the processing circuitry, and to perform the prediction in dependence on the hint.

According to a second aspect of the present techniques there is provided a system comprising:
the apparatus according to the first aspect, implemented in at least one packaged chip;
at least one system component; and
a board,
wherein the at least one packaged chip and the at least one system component are assembled on the board.

According to a third aspect of the present techniques there is provided a chip-containing product comprising the system according to the second aspect, wherein the system is assembled on a further board with at least one other product component.

According to a fourth aspect of the present techniques there is provided a method of operating an apparatus comprising a storage hierarchy for storing data items to be processed by processing circuitry, the storage hierarchy comprising:
storage circuitry configured to store a plurality of the data items; and
at least one downstream storage component accessible to the processing circuitry in a greater number of clock cycles than the storage circuitry,
the method comprising:
in response to receipt of a memory access request specifying an address from which content is to be retrieved, performing a prediction of whether the content is present in the storage circuitry prior to receiving a result of a lookup to confirm whether the content is present, and when the prediction indicates that the content is absent from the storage circuitry, issuing a storage bypass request to trigger a downstream lookup of the content in the at least one downstream storage component;
receiving a hint from upstream of the storage circuitry, the hint indicative of whether the address belongs to a set of addresses previously observed by the processing circuitry; and
performing the prediction in dependence on the hint.

According to a fifth aspect of the present techniques there is provided a non-transitory computer-readable medium storing computer-readable code for fabrication of an apparatus comprising:
a storage hierarchy for storing data items to be processed by processing circuitry, the storage hierarchy comprising:
   storage circuitry configured to store a plurality of the data items; and
   at least one downstream storage component accessible to the processing circuitry in a greater number of clock cycles than the storage circuitry; and
control circuitry responsive to receipt of a memory access request specifying an address from which content is to be retrieved, to perform a prediction of whether the content is present in the storage circuitry prior to receiving a result of a lookup to confirm whether the content is present, and when the prediction indicates that the content is absent from the storage circuitry, to issue a storage bypass request to trigger a downstream lookup of the content in the at least one downstream storage component,
wherein the control circuitry is configured to receive a hint from upstream of the storage circuitry, the hint indicative of whether the address belongs to a set of addresses previously observed by the processing circuitry, and to perform the prediction in dependence on the hint.

### BRIEF DESCRIPTION OF THE DRAWINGS

The present invention will be described further, by way of example only, with reference to configurations thereof as illustrated in the accompanying drawings, in which:

FIG. 1 schematically illustrates an apparatus according to some configurations of the present techniques;

FIG. 2 schematically illustrates an apparatus according to some configurations of the present techniques;

FIG. 3 schematically illustrates an apparatus according to some configurations of the present techniques;

FIG. 4 schematically illustrates a region table according to some configurations of the present techniques;

FIG. 5 schematically illustrates generation of a hint according to some configurations of the present techniques;

FIG. 6 schematically illustrates generation of a hint according to some configurations of the present techniques;

FIG. 7 schematically illustrates a determination of whether to issue a bypass request according to some configurations of the present techniques;

FIG. 8 schematically illustrates an apparatus according to some configurations of the present techniques;

FIG. 9 schematically illustrates an apparatus according to some configurations of the present techniques;

FIG. 10 schematically illustrates a sequence of steps according to some configurations of the present techniques;

FIG. 11 schematically illustrates a sequence of steps according to some configurations of the present techniques;

FIG. 12 schematically illustrates a sequence of steps according to some configurations of the present techniques; and

FIG. 13 schematically illustrates a system and a chip-containing product according to some configurations of the present techniques.

### DESCRIPTION OF EXAMPLE CONFIGURATIONS

Before discussing the configurations with reference to the accompanying figures, the following description of configurations is provided.

According to some configurations of the present techniques there is provided an apparatus comprising a storage hierarchy for storing data items to be processed by processing circuitry. The storage hierarchy comprises: storage circuitry configured to store a plurality of the data items, and at least one downstream storage component accessible to the processing circuitry in a greater number of clock cycles than the storage circuitry. The apparatus is provided with control circuitry responsive to receipt of a memory access request specifying an address from which content is to be retrieved, to perform a prediction of whether the content is present in the storage circuitry prior to receiving a result of a lookup to confirm whether the content is present, and when the prediction indicates that the content is absent from the storage circuitry, to issue a storage bypass request to trigger a downstream lookup of the content in the at least one downstream storage component. The control circuitry is configured to receive a hint from upstream of the storage circuitry, the hint indicative of whether the address belongs to a set of addresses previously observed by the processing circuitry, and to perform the prediction in dependence on the hint.

The apparatus is provided with the storage hierarchy to store data items. The storage hierarchy is provided with at least two storage locations in which data can be stored, the storage circuitry and the downstream storage component. The storage hierarchy may be provided with one or more further storage components which may be provided upstream of the storage circuitry, downstream of the storage circuitry and upstream of the downstream storage component, and/or downstream of the downstream storage component. For example, one or more intervening storage components may be provided between the storage circuitry and the downstream storage component.

As used herein the terms upstream and downstream refer to the positioning of the storage circuitry within the storage hierarchy. A component that is upstream of another component is positioned such that the upstream component can be accessed by the processing circuitry in fewer clock cycles than the another component. Similarly, a component that is downstream of another component is positioned so that it takes a greater number of clock cycles to access the component than the another component. The downstream storage component is located downstream from the storage circuitry and, hence, the storage circuitry is located upstream from the downstream storage component. A component that is downstream from another component may be physically positioned on a chip at a location that is geometrically further from the processing circuitry than the another component, however, this is not necessarily the case and it may be that the downstream storage component is provided as a larger storage structure that takes longer for a lookup to be performed and content to be retrieved than the another component. In the storage hierarchy a storage request may be passed from the processing circuitry to a first storage structure within the storage hierarchy and, in response to a miss in the first storage structure, the storage request may be passed sequentially through storage structures in a downstream direction until content is located and can be returned to the processing circuitry.

As the storage request is passed downstream in the storage hierarchy, the number of clock cycles required to return the content (e.g., data or instructions) will increase. As a result, where a lookup is required in the downstream storage component, there may be an increased latency due to both the number of clock cycles required to access the downstream storage component and because a lookup would first be performed in the storage circuitry before being passed to the downstream component. Whilst it may be possible to trigger a lookup in each of the storage structures (including the storage circuitry and the downstream storage structure) at a same time, this approach increases the amount of data (both requests and, potentially, returned content) that is being transmitted through the memory system and can result in reduced system performance and/or reduced power efficiency.

The storage circuitry is provided with control circuitry that is responsive to receipt of the memory access request to predict whether or not content located at the address specified in the memory access request is currently stored in the storage circuitry. The prediction is performed in fewer clock cycles than a lookup which would determine definitively whether the content is stored in the storage circuitry. The prediction may be performed either in advance of a lookup or at least partially in parallel with the lookup. Where the prediction indicates that the content is likely to be stored in the storage circuitry, the lookup proceeds with no further action being taken. However, when the prediction indicates that the content is absent from the storage circuitry (i.e., the content is predicted to not be present), then the control circuitry is configured to issue a storage bypass request to the downstream storage component. The storage bypass request triggers the downstream storage component to perform a downstream lookup to determine whether the content is present in the downstream storage component. The downstream lookup can therefore be triggered sooner than it would otherwise be if the lookup in the storage circuitry was first required to complete.

The inventors have recognised that the control circuitry may only have limited information relating to regions of memory that are present in the storage circuitry and, hence, that prediction accuracy can be improved by providing information from upstream of the storage circuitry to the control circuitry that can be used to steer (e.g., to influence or modify) the prediction. The control circuitry is therefore configured to receive a hint from upstream of the storage circuitry indicating whether the address belongs to a previous set of addresses observed by the processing circuitry. This information can be particularly useful in a cold start scenario in which execution of instructions by the processing circuitry begins in a region of memory that previously, e.g., prior to the execution of instructions in the new region, had either not been accessed by instructions executing on the processing circuitry, or that had not recently been accessed by instructions executing on the processing circuitry. In such a situation, it may be that previous memory accesses could typically be serviced by the storage circuitry, resulting in a high hit rate in the storage circuitry. However, because the region of memory being accessed has changed, there may be a sequence of memory accesses for content that is not present in the storage circuitry, but the storage circuitry may expect, e.g., based on the hit rate, that the content will be present. Hence, the hint provided by the upstream component can enable the control circuitry to identify that the content is likely to be absent from the storage circuitry in cold start scenarios. The provision of the hint can therefore improve prediction accuracy, particularly in cold start scenarios.

Whilst the storage bypass request can be triggered in advance of the lookup, in some configurations control circuitry is configured to trigger the storage bypass request such that at least a portion of the bypass request and the lookup occur in parallel. For example, the lookup may require multiple clock cycles and may be triggered in a same clock cycle as the prediction with the bypass request being triggered in a subsequent clock cycle, i.e., whilst the lookup is being performed. Alternatively, the prediction may be made in advance of the lookup with both the bypass request and the lookup triggered in the same clock cycle.

The downstream storage circuitry may be arranged to separate the downstream lookup from returning the content and, in some configurations, the at least one downstream storage component is responsive to the storage bypass request to perform the downstream lookup and to defer returning the content. The downstream lookup may therefore be performed speculatively, i.e., before it is determined whether the content is present in the storage circuitry, however, returning the content may be deferred so that the content is not returned speculatively. This approach prevents memory bandwidth being used to retrieve content that is predicted to be required but, once the lookup has completed, is subsequently identified as not being required.

For example, in some configurations the storage circuitry is responsive to the lookup resulting in a miss in the storage circuitry, to trigger a further request to the downstream component; and the at least one downstream storage component is responsive to the further request to return the content. Because the lookup may already have been speculatively triggered (in response to the bypass request), latency associated with the lookup can be hidden and the content may be returned more rapidly than if the lookup had not been speculatively performed.

Furthermore, in some configurations the control circuitry is responsive to the lookup resulting in a hit in the storage circuitry, to omit triggering the further request. The content can then be returned from the storage circuitry to a storage component upstream of the storage circuitry or to the processing circuitry without retrieving the content from the downstream storage component. In some configurations the control circuitry may issue an indication to the downstream storage component that the content is not required. The downstream storage component can then respond by cancelling the downstream lookup or discarding the result of the downstream lookup. Omitting triggering the further request prevents the content being returned from the downstream storage circuitry when it is not required, resulting in a reduction in the overall bandwidth requirements associated with the request.

The hint may be provided from a range of different structures within the apparatus. In some configurations the processing circuitry comprises region storage circuitry configured to store a plurality of entries, each of the plurality of entries identifying a respective region of address space accessed by the processing circuitry when executing instructions and metadata corresponding to the respective region of address space; and for a given memory access request identifying a given address, the hint is dependent on the metadata associated with the respective region comprising the given address. The region storage circuitry can be provided as a bespoke storage circuit or as one of a plurality of existing storage circuits provided as part of the processing circuitry. The respective regions of address space identified by each of the plurality of entries may be regions of a predefined size or regions having a variable size specified in each of the entries. Each time an address is accessed, the processing circuitry may determine if the region of address space is identified in one of the plurality of entries. If the region is identified in one of the plurality of entries, the processing circuitry may indicate in the hint that the region is a known region. Alternatively, if the region is not identified in one of the plurality of entries, the processing circuitry may allocate a new region to the region storage circuitry and indicate in the hint that the region is not a known region.

As discussed, the region storage circuitry may be provided by one or more existing storage structures. For example, in some configurations the region storage circuitry is configured to identify each of the plurality of entries with a respective program counter tag defined using fewer bits than a most significant address portion common to all addresses in the respective region of address space identified in that entry; and the processing circuitry is configured to utilise the respective program counter tag as a proxy for the most significant address portion. During processing instructions are identified by a program counter value which may be a 32-bit value or a 64-bit value. However, typically program instructions for a given process will be taken from a same region of address space and, hence, the most significant portion of the program counter value used for sequential instructions will typically be the same or, when multiple processes are executed, be one of a small group of most significant program counter bits. The region storage table is provided to allow the full program counter value to be retained but to avoid having to associated a full program counter value with each instruction or block of instructions. Instead, the instructions can be associated with a respective program counter tag which is indicative of the full program counter value but comprises fewer bits. A full program counter value can be obtained from the program counter tag by performing a lookup in the region storage circuitry. The region storage circuitry can therefore be used to provide an indication of regions of memory that have been recently accessed by the processing circuitry and, hence, can be used to generate the hint based on whether the address of the memory access request falls within a region identified in the region storage circuitry.

Whilst the presence or absence of a region from the region storage circuitry can be used for the purpose of generating the hint, in some configurations the metadata is indicative of previous memory accesses associated with the set of respective region of address space. The metadata can be used to identify, for example, how frequently a region identified in the region storage circuitry has been accessed. For example, the metadata may provide further detail indicating a frequency with which a region has been accessed, an indication of how recently a region has been accessed, or of sub-regions within the region that have been accessed. The metadata can therefore be used to provide a more refined hint than a hint that is provided based on the presence or absence of a region in the region storage circuitry alone.

In some configurations the metadata comprises usage data indicative of a utilisation of one or more further storage structures, upstream of the storage circuitry, to store content associated with the set of respective region of address space. For example, the metadata may be provided as a plurality of different metadata items each indicative of a different one of a the one or more further storage structures. Alternatively, or in addition, one or more combined counters may be provided to indicate a combined metric indicative of whether any one of a plurality of the one or more further storage structures has been used store content associated with the set of respective region of address space.

In some configurations the one or more further storage structures comprise a cache storage structure configured to provide local storage for content associated with the respective region, and the metadata comprises a miss counter indicative of a number of misses in the cache storage structure associated with the respective region. The cache storage structure may form part of the storage hierarchy and is positioned upstream from the storage circuitry. For a given region identified in the region storage circuitry, the greater the number of cache misses associated with a region, the lower the likelihood that content associated with that region will be retained in the storage circuitry. As a result, where the number of misses is above a threshold (e.g., a predefined threshold, or a dynamically adjustable threshold) the hint could be issued alongside a storage request comprising an address in the given region to indicate that it is less likely that content will be present in the storage circuitry. Because the hint is provided on a per region basis, a subsequent memory access request for a different region may not result in the hint being issued, or a hint being issued to indicate that it is more likely that content will be present in the storage circuitry.

Alternatively, or in addition, in some configurations the one or more further storage structures comprise a branch target buffer configured to store target data for branch instructions associated with the respective region, and the usage data comprises an allocation counter indicative of a number of the branch instructions allocated in the branch target buffer. Where code from a particular region is being executed, it would be natural for that code to result in allocation of branch instructions associated with (e.g., stored in) that particular region. Hence, a large number of branches being allocated for the particular region can provide an indication that the particular region is more widely accessed and it is more likely that content stored at an address comprised in the particular region would be found in the storage circuitry.

Alternatively, or in addition, in some configurations the metadata comprises a translation counter indicative of a number of page table walks associated with the set of respective region of address space. Page table walks provide a means to translate between a first address space, for example, that may be visible to processing circuitry, and a second address space, for example, that may be visible to the memory system. A page table walk, as will be known to the person of ordinary skill in the art, involves performing sequential lookups based on portions of an address of the first address space in order to arrive at the address in the second address space. Page table walks are generally high latency operations involving plural accesses to memory. Hence, address translation caches (for example, a translation lookaside buffer) are often provided to cache translations between the first address space and the second address space and, hence, to reduce the requirement for page table walks to be performed each time and address translation is required. The address translation counter can therefore be used to identify regions in which new areas of memory are being accessed, i.e., because a relatively high number of page table walks are being performed, and to identify regions in which previously observed regions of memory are being accessed, i.e., because a relatively low number of page table walks are being performed.

In some configurations the hint is indicative that a number of times that the set of addresses previously observed by the processing circuitry comprises an address specified in the memory access requests is below a predefined threshold. The control circuitry may maintain a counter which is incremented each time an address is observed that is contained in the set of addresses previously observed by the processing circuitry and that is decremented each time an address is observed that is not contained in the set of addresses previously observed by the processing circuitry. The amount by which the counter is incremented or decremented may be symmetric (i.e., the amount by which the counter is incremented is equal to the amount by which the counter is decremented) or non-symmetric (i.e., the amount by which the counter is incremented is not equal to the amount by which the counter is decremented). The counter can be compared to the predefined threshold and, when the counter is below the predefined threshold, the hint may be provided. When the counter is not below the predefined threshold the hint may be omitted.

In some configurations the apparatus comprises address translation circuitry responsive to receipt of the memory access request to perform an address translation between an address indicated in the memory access request and a further address, wherein the address translation circuitry is configured: to store translation data indicative of a plurality of address translations; in response to receipt of the memory access request, to perform a lookup to determine if the address is indicated in the translation data, and when the address is absent from the translation data, to trigger a page table walk to retrieve the address translation data; and the address translation circuitry is configured to generate the hint in dependence on whether the page table walk was triggered. The provision of the hint may therefore be more closely related to the type of memory access request that is triggered. In particular, the hint may be provided for requests associated with the page table walk. Alternatively, the hint may be more likely to be provided for requests associated with the page table walk but may be further dependent on one or more other metrics, for example, in dependence on one or more counters as described above.

As discussed, the prediction is performed in dependence on the hint. In addition, in some configurations the control circuitry is configured to perform the prediction in dependence on one or more conditions indicative of the storage circuitry. For example, one or more counters may be provided in the storage circuitry to provide an indication of whether it is likely that content associated with the address may be stored in the storage circuitry. The prediction may be based on the one or more counters or may be based on a history indicative of a history of events relating to the storage structure. In some configurations, the control circuitry may comprise a perceptron predictor and may base the prediction on the outcome of the perceptron predictor which is also dependent on the hint.

In some configurations the control circuitry is configured to maintain miss rate data indicative of a miss rate associated with lookups in the storage circuitry, and the one or more local conditions comprise the miss rate data. A high miss rate may increase the chance that the storage bypass request is issued. A low miss rate may decrease the chance that the storage bypass request is issued. One or more additional counters may also be provided, for example, an allocation counter.

Whilst the hint may be provided as a single bit that can be set to indicate whether the address belongs to the set of addresses, in some configurations the control circuitry is responsive to the hint taking a first value to bias the prediction to increase a likelihood that the storage bypass request will be issued by a first amount; and the control circuitry is responsive to the hint taking a second value to bias the prediction to increase the likelihood that the storage bypass request will be issued by a second amount greater than the first amount. The hint may therefore take multiple values. For example, the hint may be provided as a 2-bit number with the first bit indicating whether to increase the likelihood that the storage bypass request will be issued, and a second bit indicating whether to increase by the first amount or the second amount. Alternative formats with which the hint could be encoded will be readily apparent to the person of ordinary skill in the art.

Particular configurations will now be described with reference to the figures.

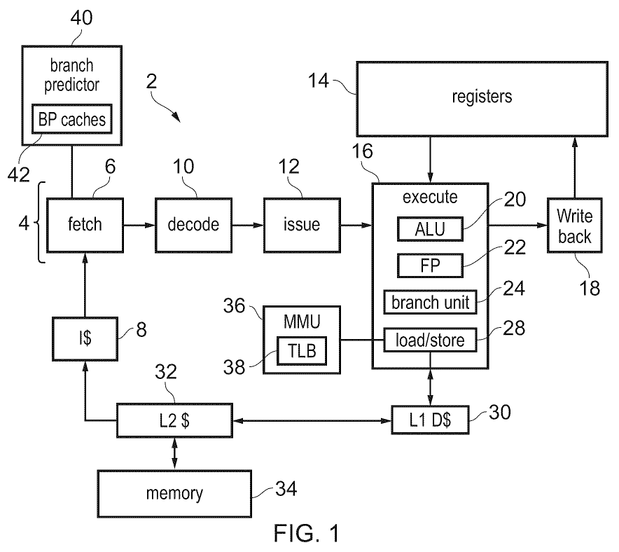

FIG. 1 schematically illustrates an example of a data processing apparatus 2 according to some configurations of the present techniques. The data processing apparatus has a processing pipeline 4 which includes a number of pipeline stages. In this example, the pipeline stages include a fetch stage 6 for fetching instructions from an instruction cache 8; a decode stage 10 for decoding the fetch program instructions to generate micro-operations to be processed by remaining stages of the pipeline; an issue stage 12 for checking whether operands required for the micro-operations are available in a register file 14 and issuing micro-operations for execution once the required operands for a given micro-operation are available; an execute stage 16 for executing data processing operations corresponding to the micro-operations, by processing operands read from the register file 14 to generate result values; and a writeback stage 18 for writing the results of the processing back to the register file 14. It will be appreciated that this is merely one example of possible pipeline architecture, and other systems may have additional stages or a different configuration of stages. For example, in an out-of-order processor a register renaming stage could be included for mapping architectural registers specified by program instructions or micro-operations to physical register specifiers identifying physical registers in the register file 14.

The execute stage 16 includes a number of processing units, for executing different classes of processing operation. For example the execution units may include a scalar arithmetic/logic unit (ALU) 20 for performing arithmetic or logical operations on scalar operands read from the registers 14; a floating point unit 22 for performing operations on floating-point values, a branch unit 24 for evaluating the outcome of branch operations and adjusting the program counter which represents the current point of execution accordingly; and a load/store unit 28 for performing load/store operations to access data in a memory system 8, 30, 32, 34. A memory management unit (MMU) 36 controls address translations between virtual addresses specified by load/store requests from the load/store unit 28 and physical addresses identifying locations in the memory system, based on address mappings defined in a page table structure stored in the memory system. The page table structure may also define memory attributes which may specify access permissions for accessing the corresponding pages of the address space, e.g. specifying whether regions of the address space are read only or readable/writable, specifying which privilege levels are allowed to access the region, and/or specifying other properties which govern how the corresponding region of the address space can be accessed. Entries from the page table structure may be cached in a translation lookaside buffer (TLB) 38 which is a cache maintained by the MMU 36 for caching page table entries or other information for speeding up access to page table entries from the page table structure shown in memory.

In this example, the memory system includes a level one data cache 30, the level one instruction cache 8, a shared level two cache 32 and main system memory 34. It will be appreciated that this is just one example of a possible memory hierarchy and other arrangements of caches can be provided. The specific types of processing unit 20 to 28 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline architecture, and the processor may include many other elements not illustrated for conciseness.

The apparatus 2 also has a branch predictor 40 which may include one or more branch prediction caches 42 for caching prediction information used to form predictions of branch behaviour of branch instructions to be executed by the branch unit 24. The predictions provided by the branch predictor 40 may be used by the fetch stage 6 to determine the sequence of addresses from which instructions are to be fetched from the instruction cache 8 or memory system. The branch prediction caches may include a number of different forms of cache structure, including a branch target buffer (BTB) which may cache entries specifying predictions of whether certain blocks of addresses are predicted to include any branches, and if so, the instruction address offsets (relative to the start address of the block) and predicted target addresses of those branches. Also the branch prediction caches 42 could include branch direction prediction caches which cache information for predicting, if a given block of instruction addresses is predicted to include at least one branch, whether the at least one branch is predicted to be taken or not taken.

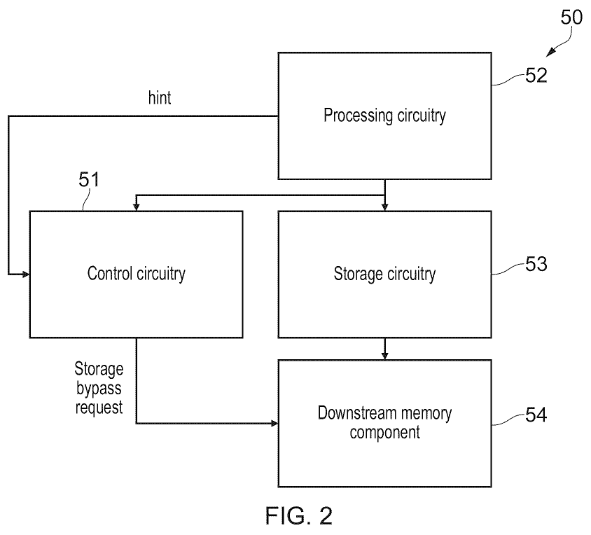

FIG. 2 schematically illustrates an apparatus 50 according to some configurations of the present techniques. The apparatus 50 is provided with processing circuitry 52, storage circuitry 53, a downstream memory component 54 and control circuitry 51. The processing circuitry 51 may be arranged as a processing pipeline, for example, as illustrated in FIG. 1, and is configured to perform processing operations in response to a sequence of instructions. The storage circuitry 53 and the downstream memory component 54 are arranged in a storage hierarchy with the downstream memory component 54 being provided downstream of the storage circuitry 53 which, in turn, is provided downstream of the processing circuitry 52. The storage circuitry 53 and the downstream memory component 54 are each provided to store data items to be accessed by the processing circuitry 52 when processing instructions.

In response to a memory access request specifying an address from which content is to be retrieved, the storage circuitry 53 is configured to perform a lookup to determine if the content is stored in the storage circuitry 53. If the content is stored in the storage circuitry 53, the content is returned to the processing circuitry 52. On the other hand, if the content is not stored in the storage circuitry 53, then the request is passed to the downstream memory component 54.

The memory access request is also received by the control circuitry 51 which performs a prediction of whether the content is present in the storage circuitry 53. The prediction is performed in advance of a result of the lookup being known. When the prediction indicates that the content is absent from the storage circuitry 53, the control circuitry 51 issues a storage bypass request to the downstream memory component 54 to trigger a downstream lookup to be performed in the downstream memory component 54. The control circuitry 51 also receives a hint from upstream of the storage circuitry (from the processing circuitry 52 in the illustrated configuration). The hint is indicative of whether the address specified in the memory access request belongs to a set of addresses that have been previously observed by the processing circuitry. The control circuitry 51 performs the prediction in dependence on the hint.

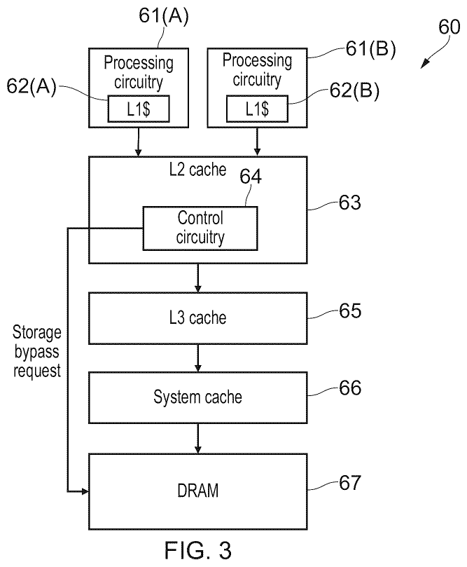

FIG. 3 schematically illustrates a further example of an apparatus 60 according to some configurations of the present techniques. The apparatus is 60 comprises a storage hierarchy and processing circuitry 61. In particular, the apparatus is provided with first processing circuitry 61(A), and second processing circuitry 61(B). The storage hierarchy comprises a level 1 cache 62 where a first level one cache 62(A) is comprised in the first processing circuitry 61(A) and a second level one cache 62(B) is comprised in the second processing circuitry 61(B). The storage hierarchy also comprises a level 2 cache 63, a level 3 cache 65, a system cache 66, and DRAM 67.

In the illustrated configuration the DRAM 67 is an example of a downstream memory component and the L2 cache 63 is an example of the storage circuitry. It will be readily apparent to the skilled person that these particular storage structures are selected for illustrative purpose and that the storage circuitry may be any one of the caches within the memory hierarchy, e.g., the level 1 cache 62, the level 2 cache 63, the level 3 cache 65, or the system cache 67. Similarly, the downstream memory component may be any of the components of the storage hierarchy that is downstream of the storage circuitry. For example, when the L2 cache is the storage circuitry, the downstream memory component may be any one of the level 3 cache 65, the system cache 66 or the DRAM 67. Similarly, when the L3 cache is the storage circuitry, the downstream memory component may be any one of the system cache 66 or the DRAM 67.

The level 2 cache 63 is provided with control circuitry that is arranged to predict whether content requested in a memory access request is present in the level 2 cache 63 and to issue a storage bypass request in dependence on the prediction to the DRAM 67. The DRAM 67 is responsive to the lookup request to perform a downstream lookup to determine whether the content is present in the DRAM 67. Once the lookup is complete, the DRAM 67 defers returning the content until a further request is received. Subsequent to the lookup in the level 2 cache 63, i.e., once it is actually determined whether the content is stored in the level 2 cache 63 (i.e., the lookup completes), the control circuitry may trigger a further request to the DRAM 67 to cause the content to be returned to the processing circuitry 61.

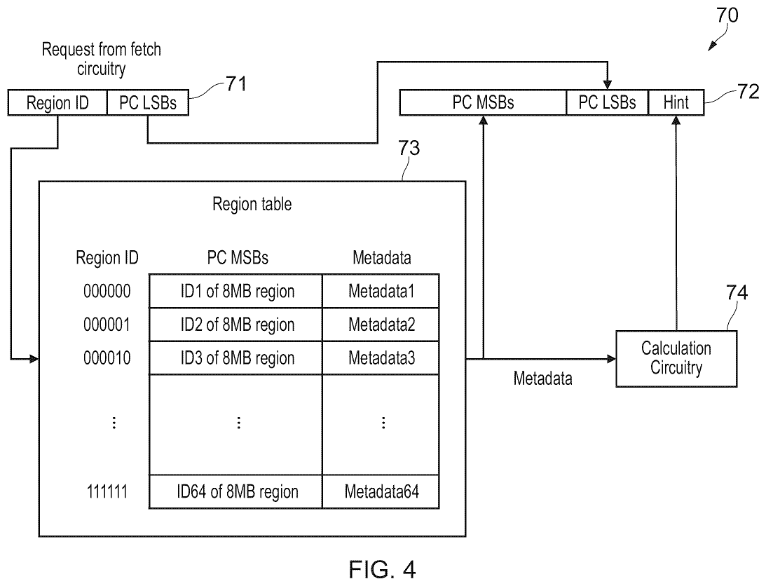

FIG. 4 schematically illustrates an example of region storage circuitry 73 storing a region table identifying metadata to be used to determine whether a hint indicating that the address belongs to a set of addresses previously observed by the processing circuitry is to be provided with a memory access request. The region storage circuitry 73 is provided upstream of the storage circuitry and may, for example, be provided in the processing circuitry. The region table comprises a plurality of entries indexed by a region ID which can be used by processing circuitry as a proxy for the most significant portion of a program counter value. In the illustrated configuration, 64 region IDs are provided with each one mapping to an 8 MB region of address space. Each region of the region table in the region storage circuitry 73 also comprises metadata used to determine whether a hint should be provided with the memory access request. In operation, a memory access request 71 is received from fetch circuitry. The memory access request specifies a region identifier and a set of LSBs (Least Significant Bits) of the program counter value. The region storage circuitry 73 receives the region ID and performs a lookup in the region table to determine the Most Significant Bits (MSBs) of the program counter that are represented by the region identifier. The MSBs are output from the region storage circuitry 73 and concatenated with the LSBs to generate a full address for the memory access request 72. In addition, metadata associated with the region in the region table is output to calculation circuitry 74 which determines whether a hint is to be output, i.e., whether a hint bit is to be set or not within the memory access request 72. The memory access request 72 may then be issued to the storage hierarchy.

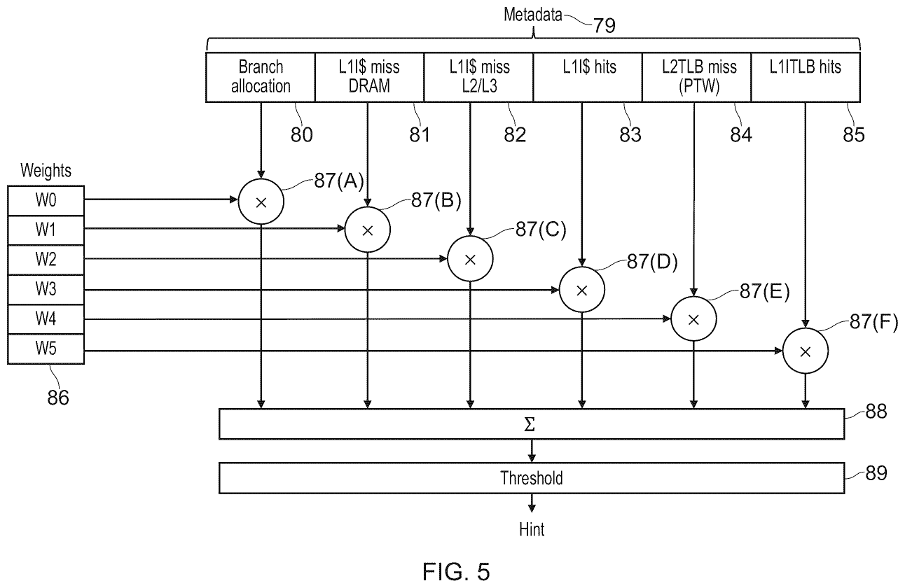

FIG. 5 schematically illustrates an example operation of the calculation circuitry 74 according to some configurations of the present techniques. The calculation circuitry 74 receives metadata 79 from the region storage circuitry 73. In the illustrated configuration the metadata 79 includes a branch allocation count 80, a count of misses in the instruction cache that are brought from DRAM 81, a count of the instruction cache misses that are brought from the level 2 cache or the level 3 cache 82, a count of hits in the instruction cache 83, a count of requests from a memory management unit that require a page table walk 84 and a count of hits in the level 1 instruction translation lookaside buffer. Each of these counts is multiplied by a corresponding one of a set of weights 86 through multiplication circuitry 87 and is output to summation circuitry 88 to be summed. The result is passed to threshold circuitry 89 which compares the summed value to a threshold. If the value exceeds the threshold then a hint is output (e.g., a hint bit is set to a logical 1). If the threshold is not exceeded, then the hint is not output (e.g., the hint bit is set to a logical 0).

It will be readily apparent to the person of ordinary skill in the art that the metadata 79 illustrated in FIG. 5 is provided by way of example, and that additional or alternative metrics could be used for the metadata 79. For example, the metadata could include a separate count of L1ITLB misses. Alternatively, the L1ITLB hits may be incremented in response to a hit in the L1ITLB and decremented in response to a miss in the L1ITLB. The amount by which the L1ITLB hits count is incremented may be the same or different to the amount by which the count is decremented. As a further example, the metadata 79 may include a separate count for L2TLB hits. Alternatively, the L2TLB miss count may be incremented for misses and decremented for hits.

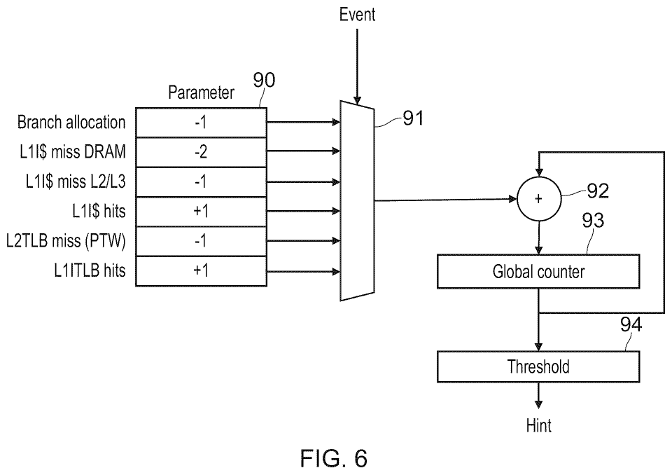

FIG. 6 schematically illustrates an alternative example for determining whether to output a hint. Rather than storing multiple items of metadata (as illustrated in FIG. 6), a global counter 92 is provided. Each time an event occurs, for example, a branch allocation, a miss in the instruction cache that is brought from DRAM, an instruction cache miss that is brought from the level 2 cache or the level 3 cache, a hit in the instruction cache, a request from a memory management unit that requires a page table walk, or a hit in the level 1 instruction translation lookaside buffer, an indication of the event is provided to switch circuitry 91. The switch circuitry receives a set of weights 90 associated with each of the events. The appropriate weight for the event is selected by the switch circuitry 91 and is passed to summation circuitry 92 along with a current value of the global counter 93. The global counter is then updated and is stored as the metadata in the region storage table 73. During calculation the calculation circuitry 74 determines whether to output a hint by comparing the global counter 93 against a threshold 94 and, if the value exceeds the threshold, outputs the hint.

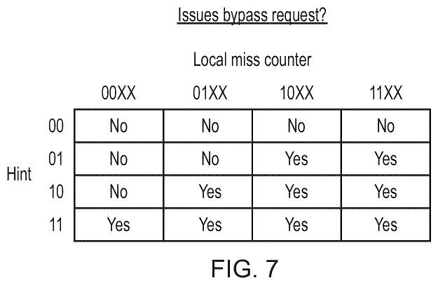

FIG. 7 schematically illustrates an example of the prediction made by the control circuitry based on a hint received from upstream of the storage circuitry and a local miss counter configured to count misses in the storage circuitry. The local miss counter is incremented for each miss in the storage circuitry and is decremented in response to a hit in the storage circuitry. The decision is based on the hint value and the two most significant bits of the local miss counter. In the illustrated configuration the local miss counter is illustrated as a four-bit counter in which the two least significant bits are not decisive when predicting whether to issue the storage bypass request. The hint value is provided as a 2-bit value with a higher binary value indicating that it is more likely that the address provided in the storage access request is accessing a new region of memory. The prediction of whether or not to issue the local bypass is determined by performing a two-way lookup based on the hint and the two most significant bits of the local miss counter.

When the hint value is equal to 00, indicating that it is highly unlikely that the address is in a new region of memory, the storage bypass request is issued only when the most significant bits of the local miss counter are equal to 11, indicating a large number of misses in the local storage circuitry. Otherwise, when the hint value is equal to 00 and the most significant bits of local miss counter take a value other than 11, then the storage bypass request is not issued.

When the hint value is equal to 01, indicating that it is unlikely that the address is in a new region of memory, the storage bypass request is issued when the most significant bits of the local miss counter are equal to 10 or 11. Otherwise, when the hint value is equal to 01 and the most significant bits of the local miss counter are equal to 00 or 01, then the storage bypass request is not issued.

When the hint value is equal to 10, indicating that it is likely that the address is in a new region of memory, the storage bypass request is issued when the most significant bits of the local miss counter are equal to 01, 10 or 11. Otherwise, when the hint value is equal to 10 and the most significant bits of the local miss counter are equal to 00, then the storage bypass request is not issued.

When the hint value is equal to 11, indicating that it is highly likely that the address is in a new region of memory, the storage bypass request is issued regardless of the value of the local miss counter.

Whilst the local miss counter of FIG. 7 is illustrated as having 4 bits, it will be readily apparent to the skilled person that the local miss counter could be provided having a greater bit-width with the prediction being based on the two most significant bits, the three most significant bits, or any subset of the bits in combination with the hint value. Furthermore, the hint value could be provided as a single bit or as a greater number of bits dependent on the implementation. It will be further apparent that the precise values for which the storage bypass request is issued may vary dependent on the implementation with some implementations opting for a more bandwidth conservative approach in which the storage bypass request is less likely to be issued and some implementations opting for a more aggressive approach in which the storage bypass request is more likely to be issued. Furthermore, the control circuitry may be provided with more advanced prediction circuitry, for example, history based prediction circuitry or perceptron based prediction circuitry.

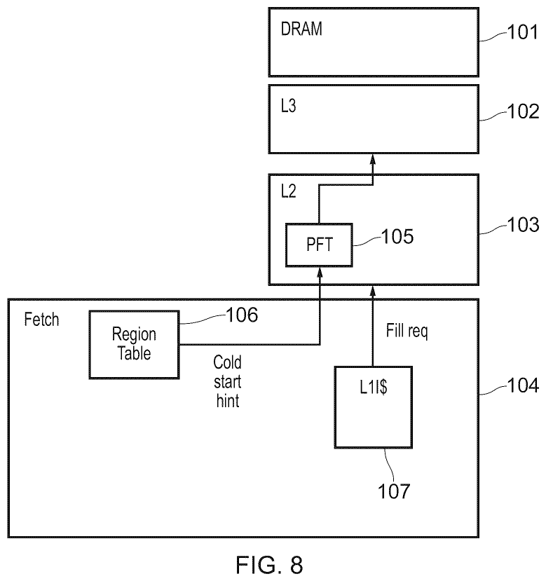

FIG. 8 schematically illustrates an example of an apparatus according to some configurations of the present techniques. The apparatus is provided with fetch circuitry 104, a level 2 (L2) cache 103, a level 3 (L3) cache 102, and DRAM 101. The fetch circuitry 104 is provided with a level 1 (L1) instruction cache 107 and a region table 106. The L1 instruction cache 107 is configured to issue fill requests (an example of a memory access request) to the L2 cache to retrieve instructions for execution by processing circuitry (not illustrated). The L2 cache is provided with a prefetch target (PFT) circuit (an example of control circuitry) 105 configured to determine whether to issue a storage bypass request to a downstream component, i.e., to either the L3 cache 102 or the DRAM 101 in response to receipt of the fill request. The PFT makes the prediction based on a cold start hint provided by the region table 106 which is configured to store metadata indicative of access to different regions of memory that have been accessed by the processing circuitry and, when the prediction indicates that the content is not present in the L2 cache 103, the PFT issues the storage bypass request to the L3 cache.

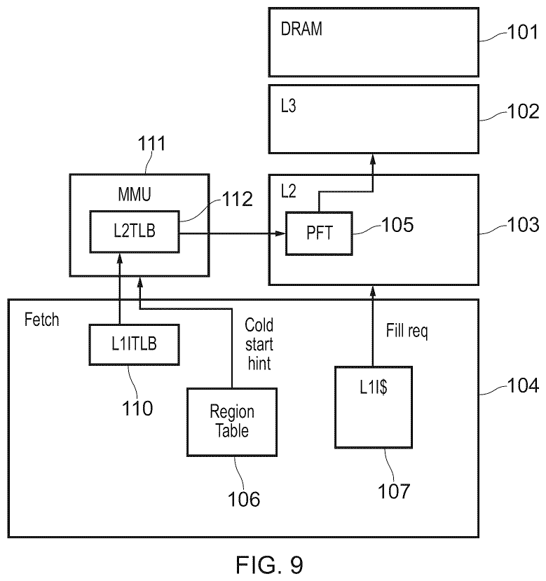

FIG. 9 schematically illustrates a further example of an apparatus according to some configurations of the present technique. As in FIG. 8, the apparatus is provided with fetch circuitry 104, a level 2 (L2) cache 103, a level 3 (L3) cache 102, and DRAM 101. In addition, the apparatus is provided with a memory management unit (MMU) 111. The fetch circuitry 104 is provided with a level 1 (L1) instruction cache 107, a region table 106, and a level 1 instruction translation lookaside buffer (ITLB) 110 configured to store address translations and partial address translations between addresses observed by the processing circuitry (e.g., virtual addresses) and addresses used by the storage hierarchy (e.g., physical addresses). The MMU 111 is configured to provide address translations between addresses observed by the processing circuitry and addresses observed by the storage hierarchy in the event that the translations are not cached (stored) in the L1ITLB 110. The MMU 111 is provided with a level 2 translation lookaside buffer (L2TLB) 112 configured to store translations and partial translations. The MMU is responsive to receipt of an address to be translated (i.e., addresses for which the translation is not cached in the L1ITLB 110) to perform a lookup in the L2TLB 112. Where a translation (or a partial translation) is cached in the L2TLB 112, that translation (or partial translation) can be used to identify the address to be provided to the storage hierarchy to be used in the memory access request (or, in the case of a partial translation, as part of a page table walk to identify a full translation). Where the translation is not present in the L2TLB 112, the MMU 111 triggers a page table walk to retrieve the address translation. In the illustrated configuration, the hint provided to the PFT 105 is determined based on the cold start hint provided from the region table 106, and a determination of whether the translation is cached in the L1ITLB 110 and/or the L2TLB 112. When the prediction indicates that the content is not present in the L2 cache 103, the PFT issues the storage bypass request to the L3 cache. In the illustrated configuration, the information is combined to provide the hint to the PFT 105. However, in alternative configurations, the information may be returned to the region table 106 to be stored as metadata in the region table 106. This information can then be used in future memory access requests to determine the hint value.

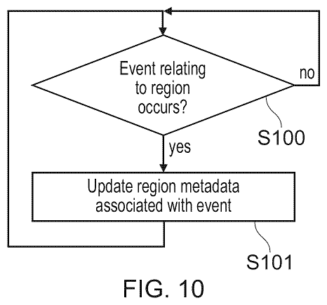

FIG. 10 schematically illustrates a sequence of steps carried out according to some configurations of the present techniques to maintain metadata in association with a particular region of memory. Flow begins at step S100 where it is determined if an event relating to a region has occurred. For example, the event may be any of the events identified in FIGS. 5 and 6. If, at step S100, it is determined that no event has occurred, then flow remains at step S100. If, at step S100, it is determined that an event relating to a region has occurred, then flow proceeds to step S101. At step S101, the metadata for the region and associated with the event is updated. For example, where the metadata is provided as a global counter, the global counter is updated to identify the occurrence of the event. Alternatively, where the metadata is provided as multiple counters, the metadata associated with the particular event is updated to identify the occurrence of that event. Flow then returns to step S100.

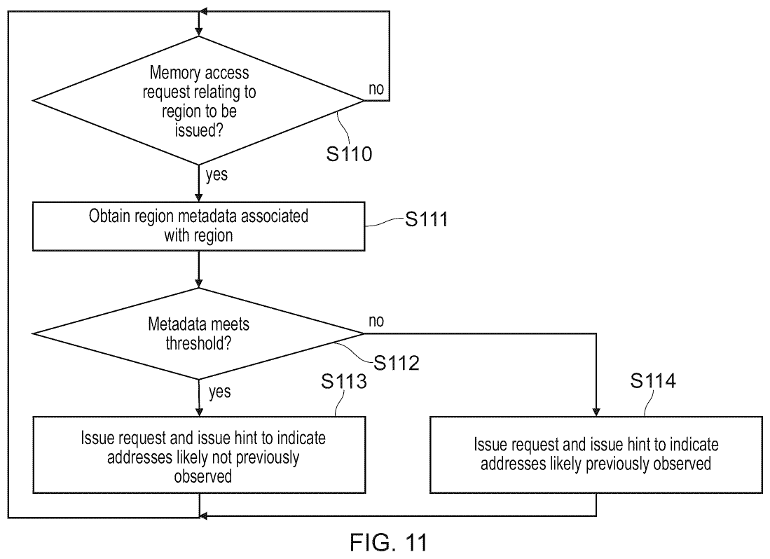

FIG. 11 schematically illustrates a sequence of steps carried out by a component upstream of the storage circuitry according to some configurations of the present techniques. Flow begins at step S110 where it is determined if a memory access request relating to a region is to be issued. If, at step S110, it is determined that no memory access request is being issued, then flow remains at step S110. If, at step S110, it is determined that a memory access request relating to a region is being issued, then flow proceeds to step S111. At step S111 metadata associated with the region is obtained. Flow then proceeds to step S112 where it is determined whether the metadata meets a threshold. If, at step S112, it is determined that the metadata meets the threshold, then flow proceeds to step S113 where the memory access request is issued along with a hint to indicate that it is likely that the address is not in a group of previously observed addresses. Flow then returns to step S110. If, at step S112, it is determined that the metadata does not meet the threshold, then flow proceeds to step S114 where the memory access request is issued along with a hint to indicate that the address is likely to be in a group of previously observed addresses. Flow then returns to step S110.

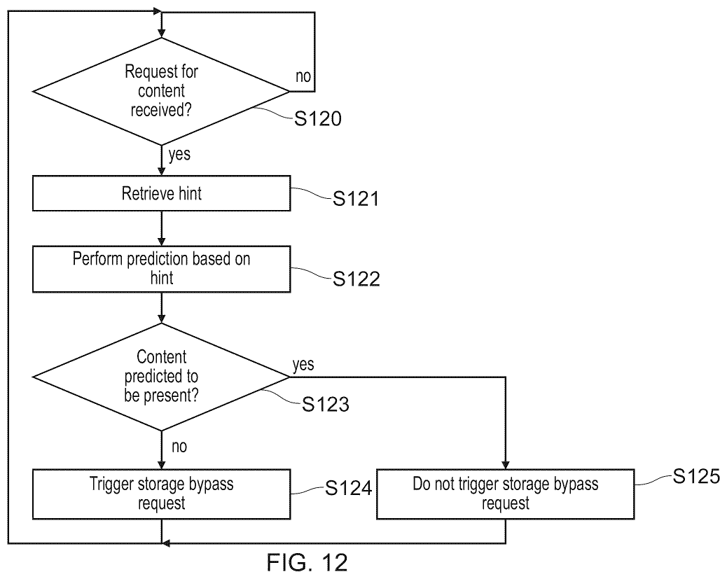

FIG. 12 schematically illustrates a sequence of steps carried out by control circuitry according to some configurations of the present techniques. Flow begins at step S120 where it is determined if a memory access request for content has been received. If, at step S120, it is determined that the request for content has not been received, then flow remains at step S120. If, at step S120, it is determined that a request for content has been received, then flow proceeds to step S121 where a hint is retrieved from an upstream component. Flow then proceeds to step S122 where a prediction is performed based on the hint. Flow then proceeds to step S123 where it is determined if the content is predicted to be present. If, at step S123, it is determined that the content is predicted to be not present, then flow proceeds to step S124 where a storage bypass request is triggered before flow returns to step S120. If, at step S123, it is determined that content is predicted to be present, then flow proceeds to step S125 where the storage bypass request is not triggered. Flow then returns to step S120.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

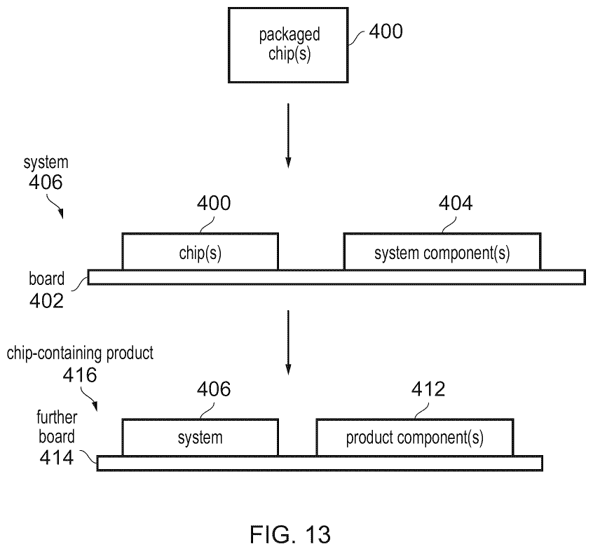

As shown in FIG. 13, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc. ; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company. The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, System Verilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and System Verilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In brief overall summary there is provided an apparatus comprising a storage hierarchy. The storage hierarchy comprises: storage circuitry configured to store a plurality of data items, and a downstream storage component. The apparatus is also provided with control circuitry responsive to receipt of a memory access request specifying an address from which content is to be retrieved, to perform a prediction of whether the content is present in the storage circuitry, and when the prediction indicates that the content is absent from the storage circuitry, to issue a storage bypass request to trigger a downstream lookup of the content in the downstream storage component. The control circuitry is configured to receive a hint from upstream of the storage circuitry, the hint indicative of whether the address belongs to a set of addresses previously observed by the processing circuitry, and to perform the prediction in dependence on the hint.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative configurations of the invention have been described in detail herein with reference to the accompanying drawings, it is to be understood that the invention is not limited to those precise configurations, and that various changes, additions and modifications can be effected therein by one skilled in the art without departing from the scope of the invention as defined by the appended claims. For example, various combinations of the features of the dependent claims could be made with the features of the independent claims without departing from the scope of the present invention.

Some configurations of the present techniques are described by the following numbered clauses:

Clause 1. An apparatus comprising:
a storage hierarchy for storing data items to be processed by processing circuitry, the storage hierarchy comprising:
   storage circuitry configured to store a plurality of the data items; and
   at least one downstream storage component accessible to the processing circuitry in a greater number of clock cycles than the storage circuitry; and
control circuitry responsive to receipt of a memory access request specifying an address from which content is to be retrieved, to perform a prediction of whether the content is present in the storage circuitry prior to receiving a result of a lookup to confirm whether the content is present, and when the prediction indicates that the content is absent from the storage circuitry, to issue a storage bypass request to trigger a downstream lookup of the content in the at least one downstream storage component,
wherein the control circuitry is configured to receive a hint from upstream of the storage circuitry, the hint indicative of whether the address belongs to a set of addresses previously observed by the processing circuitry, and to perform the prediction in dependence on the hint.

Clause 2. The apparatus of clause 1, wherein control circuitry is configured to trigger the storage bypass request such that at least a portion of the bypass request and the lookup occur in parallel.

Clause 3. The apparatus of clause 1 or clause 2, wherein the at least one downstream storage component is responsive to the storage bypass request to perform the downstream lookup and to defer returning the content.

Clause 4. The apparatus of clause 3, wherein:
the storage circuitry is responsive to the lookup resulting in a miss in the storage circuitry, to trigger a further request to the downstream component; and
the at least one downstream storage component is responsive to the further request to return the content.

Clause 5. The apparatus of clause 4, wherein the control circuitry is responsive to the lookup resulting in a hit in the storage circuitry, to omit triggering the further request. Clause 6. The apparatus of any preceding clause, wherein:
the processing circuitry comprises region storage circuitry configured to store a plurality of entries, each of the plurality of entries identifying a respective region of address space accessed by the processing circuitry when executing instructions and metadata corresponding to the respective region of address space; and
for a given memory access request identifying a given address, the hint is dependent on the metadata associated with the respective region comprising the given address.

Clause 7. The apparatus of clause 6, wherein:
the region storage circuitry is configured to identify each of the plurality of entries with a respective program counter tag defined using fewer bits than a most significant address portion common to all addresses in the respective region of address space identified in that entry; and
the processing circuitry is configured to utilise the respective program counter tag as a proxy for the most significant address portion.

Clause 8. The apparatus of clause 6 or clause 7, wherein the metadata is indicative of previous memory accesses associated with the set of respective region of address space.

Clause 9. The apparatus of any of clauses 6 to 8, wherein the metadata comprises usage data indicative of a utilisation of one or more further storage structures, upstream of the storage circuitry, to store content associated with the set of respective region of address space.

Clause 10. The apparatus of clause 9, wherein the one or more further storage structures comprise at least one of:
a cache storage structure configured to provide local storage for content associated with the respective region, and the metadata comprises a miss counter indicative of a number of misses in the cache storage structure associated with the respective region; and
a branch target buffer configured to store target data for branch instructions associated with the respective region, and the usage data comprises an allocation counter indicative of a number of the branch instructions allocated in the branch target buffer. Clause 11. The apparatus of any of clauses 7 to 10, wherein the metadata comprises a translation counter indicative of a number of page table walks associated with the set of respective region of address space.

Clause 12. The apparatus of any preceding clause, wherein the hint is indicative that a number of times that the set of addresses previously observed by the processing circuitry comprises an address specified in the memory access requests is below a predefined threshold.

Clause 13. The apparatus of any preceding clause, comprising address translation circuitry responsive to receipt of the memory access request to perform an address translation between an address indicated in the memory access request and a further address,
wherein the address translation circuitry is configured:
   to store translation data indicative of a plurality of address translations;
   in response to receipt of the memory access request, to perform a lookup to determine if the address is indicated in the translation data, and when the address is absent from the translation data, to trigger a page table walk to retrieve the address translation data; and
   the address translation circuitry is configured to generate the hint in dependence on whether the page table walk was triggered.

Clause 14. The apparatus of any preceding clause, wherein the control circuitry is configured to perform the prediction in dependence on one or more conditions indicative of the storage circuitry.

Clause 15. The apparatus of clause 14, wherein the control circuitry is configured to maintain miss rate data indicative of a miss rate associated with lookups in the storage circuitry, and the one or more local conditions comprise the miss rate data.

Clause 16. The apparatus of any preceding clause, wherein:

the control circuitry is responsive to the hint taking a first value to bias the prediction to increase a likelihood that the storage bypass request will be issued by a first amount; and
the control circuitry is responsive to the hint taking a second value to bias the prediction to increase the likelihood that the storage bypass request will be issued by a second amount greater than the first amount.

Clause 17. A system comprising:
the apparatus of any preceding clause, implemented in at least one packaged chip;
at least one system component; and
a board,
wherein the at least one packaged chip and the at least one system component are assembled on the board.

Clause 18. A chip-containing product comprising the system of clause 17, wherein the system is assembled on a further board with at least one other product component.

Clause 19. A method of operating an apparatus comprising a storage hierarchy for storing data items to be processed by processing circuitry, the storage hierarchy comprising:
storage circuitry configured to store a plurality of the data items; and
at least one downstream storage component accessible to the processing circuitry in a greater number of clock cycles than the storage circuitry,
the method comprising:
in response to receipt of a memory access request specifying an address from which content is to be retrieved, performing a prediction of whether the content is present in the storage circuitry prior to receiving a result of a lookup to confirm whether the content is present, and when the prediction indicates that the content is absent from the storage circuitry, issuing a storage bypass request to trigger a downstream lookup of the content in the at least one downstream storage component;
receiving a hint from upstream of the storage circuitry, the hint indicative of whether the address belongs to a set of addresses previously observed by the processing circuitry; and
performing the prediction in dependence on the hint.

Clause 20. A non-transitory computer-readable medium storing computer-readable code for fabrication of the apparatus of any of clauses 1 to 16.

We claim:

1. An apparatus comprising:
a storage hierarchy for storing data items to be processed by processing circuitry, the storage hierarchy comprising:
storage circuitry configured to store a plurality of the data items; and
at least one downstream storage component accessible to the processing circuitry in a greater number of clock cycles than the storage circuitry; and
control circuitry responsive to receipt of a memory access request specifying an address from which content is to be retrieved, to perform a prediction of whether the content is present in the storage circuitry prior to receiving a result of a lookup to confirm whether the content is present, and when the prediction indicates that the content is absent from the storage circuitry, to issue a storage bypass request to trigger a downstream lookup of the content in the at least one downstream storage component,
wherein the control circuitry is configured to receive a hint from upstream of the storage circuitry, the hint indicative of whether the address belongs to a set of addresses previously observed by the processing circuitry, and to perform the prediction in dependence on the hint.

2. The apparatus of claim 1, wherein control circuitry is configured to trigger the storage bypass request such that at least a portion of the bypass request and the lookup occur in parallel.

3. The apparatus of claim 1, wherein the at least one downstream storage component is responsive to the storage bypass request to perform the downstream lookup and to defer returning the content.

4. The apparatus of claim 3, wherein:
the storage circuitry is responsive to the lookup resulting in a miss in the storage circuitry, to trigger a further request to the downstream component; and
the at least one downstream storage component is responsive to the further request to return the content.

5. The apparatus of claim 4, wherein the control circuitry is responsive to the lookup resulting in a hit in the storage circuitry, to omit triggering the further request.

6. The apparatus of claim 1, wherein:
the processing circuitry comprises region storage circuitry configured to store a plurality of entries, each of the plurality of entries identifying a respective region of address space accessed by the processing circuitry when executing instructions and metadata corresponding to the respective region of address space; and
for a given memory access request identifying a given address, the hint is dependent on the metadata associated with the respective region comprising the given address.

7. The apparatus of claim 6, wherein:
the region storage circuitry is configured to identify each of the plurality of entries with a respective program counter tag defined using fewer bits than a most significant address portion common to all addresses in the respective region of address space identified in that entry; and
the processing circuitry is configured to utilise the respective program counter tag as a proxy for the most significant address portion.

8. The apparatus of claim 6, wherein the metadata is indicative of previous memory accesses associated with the set of respective region of address space.

9. The apparatus of claim 6, wherein the metadata comprises usage data indicative of a utilisation of one or more further storage structures, upstream of the storage circuitry, to store content associated with the set of respective region of address space.

10. The apparatus of claim 9, wherein the one or more further storage structures comprise at least one of:
a cache storage structure configured to provide local storage for content associated with the respective region, and the metadata comprises a miss counter indicative of a number of misses in the cache storage structure associated with the respective region; and
a branch target buffer configured to store target data for branch instructions associated with the respective region, and the usage data comprises an allocation counter indicative of a number of the branch instructions allocated in the branch target buffer.

11. The apparatus of claim 7, wherein the metadata comprises a translation counter indicative of a number of page table walks associated with the set of respective region of address space.

12. The apparatus of claim 1, wherein the hint is indicative that a number of times that the set of addresses previously observed by the processing circuitry comprises an address specified in the memory access requests is below a predefined threshold.

13. The apparatus of claim 1, comprising address translation circuitry responsive to receipt of the memory access request to perform an address translation between an address indicated in the memory access request and a further address,
wherein the address translation circuitry is configured:
to store translation data indicative of a plurality of address translations;
in response to receipt of the memory access request, to perform a lookup to determine if the address is indicated in the translation data, and when the address is absent from the translation data, to trigger a page table walk to retrieve the address translation data; and
the address translation circuitry is configured to generate the hint in dependence on whether the page table walk was triggered.

14. The apparatus of claim 1, wherein the control circuitry is configured to perform the prediction in dependence on one or more conditions indicative of the storage circuitry.

15. The apparatus of claim 14, wherein the control circuitry is configured to maintain miss rate data indicative of a miss rate associated with lookups in the storage circuitry, and the one or more local conditions comprise the miss rate data.

16. The apparatus of claim 1, wherein:
the control circuitry is responsive to the hint taking a first value to bias the prediction to increase a likelihood that the storage bypass request will be issued by a first amount; and
the control circuitry is responsive to the hint taking a second value to bias the prediction to increase the likelihood that the storage bypass request will be issued by a second amount greater than the first amount.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A method of operating an apparatus comprising a storage hierarchy for storing data items to be processed by processing circuitry, the storage hierarchy comprising:
storage circuitry configured to store a plurality of the data items; and
at least one downstream storage component accessible to the processing circuitry in a greater number of clock cycles than the storage circuitry,
the method comprising:
in response to receipt of a memory access request specifying an address from which content is to be retrieved, performing a prediction of whether the content is present in the storage circuitry prior to receiving a result of a lookup to confirm whether the content is present, and when the prediction indicates that the content is absent from the storage circuitry, issuing a storage bypass request to trigger a downstream lookup of the content in the at least one downstream storage component;
receiving a hint from upstream of the storage circuitry, the hint indicative of whether the address belongs to a set of addresses previously observed by the processing circuitry; and
performing the prediction in dependence on the hint.

20. A non-transitory computer-readable medium storing computer-readable code for fabrication of an apparatus comprising:
a storage hierarchy for storing data items to be processed by processing circuitry, the storage hierarchy comprising:
storage circuitry configured to store a plurality of the data items; and
at least one downstream storage component accessible to the processing circuitry in a greater number of clock cycles than the storage circuitry; and
control circuitry responsive to receipt of a memory access request specifying an address from which content is to be retrieved, to perform a prediction of whether the content is present in the storage circuitry prior to receiving a result of a lookup to confirm whether the content is present, and when the prediction indicates that the content is absent from the storage circuitry, to issue a storage bypass request to trigger a downstream lookup of the content in the at least one downstream storage component,
wherein the control circuitry is configured to receive a hint from upstream of the storage circuitry, the hint indicative of whether the address belongs to a set of addresses previously observed by the processing circuitry, and to perform the prediction in dependence on the hint.
